(19) United States
(12) Patent Application Publication
(10) Pub. No.: US 2014/0092524 A1
(43) Pub. Date: Apr. 3, 2014

(54) CAPACITOR AND METHOD OF MANUFACTURING THE SAME

(71) Applicant: SAMSUNG ELECTRO-MECHANICS CO., LTD., Suwon (KR)

(72) Inventors: Tae Yoon KIM, Gyunggi-do (KR); Sung Min CHO, Gyunggi-do (KR); Young Sik KANG, Gyunggi-do (KR)

(73) Assignee: SAMSUNG ELECTRO-MECHANICS CO., LTD., Suwon (KR)

(21) Appl. No.: 13/735,614

(22) Filed: Jan. 7, 2013

(30) Foreign Application Priority Data
Sep. 28, 2012 (KR) 10-2012-0109306

(51) Int. Cl. H01G 4/01; H01G 4/008; H01G 4/06

(52) U.S. Cl. CPC H01G 4/01; H01G 4/06; H01G 4/008
USPC 361/305; 361/311; 361/303; 156/60; 156/154

(57) ABSTRACT

There is provided a capacitor, including: a substrate part including a first substrate having a groove portion and a second substrate positioned above the first substrate and having a protrusion portion; a first capacitance part formed on one surface of the first substrate and having a shape corresponding to that of the groove portion; and a second capacitance part formed on one surface of the second substrate and having a shape corresponding to that of the protrusion portion.

### CROSS-REFERENCE TO RELATED APPLICATIONS

This application claims the priority of Korean Patent Application No. 10-2012-0109306 filed on Sep. 28, 2012, in the Korean Intellectual Property Office, the disclosure of which is incorporated herein by reference.

### BACKGROUND OF THE INVENTION

1. Field of the Invention

The present invention relates to a capacitor and a method of manufacturing the same.

2. Description of the Related Art

As the market for mobile communications devices and portable electronic devices has recently expanded, capacitors having an ultra-small size and high capacitance are increasingly demanded. For this reason, research into multilayer ceramic capacitors (MLCCs) having a small size and high capacitance have been actively undertaken. However, a multilayer ceramic capacitor is configured of several tens to several hundreds of ceramic and internal electrode layers, and thus, there is a limitation in reducing the thickness thereof.

In order to solve this problem, a thin film silicon capacitor has been recently developed, in which a groove portion such as a trench or a protrusion portion such as a pillar is formed on a silicon substrate and an electrode layer-dielectric layer-electrode layer is formed thereon. The surface area of the thin film silicon capacitor may be increased due to the groove portion or the protrusion portion, and thus can secure a high level of capacitance, even with reduced thickness.

However, the thin film capacitor may only employ one of the groove portion or the protrusion portion, and thus, the area increasing efficiency thereof is relatively lower than that of an existing multilayer ceramic capacitor. Therefore, there is a limitation in increasing capacitance of the capacitor. In addition, in the case in which a plurality of capacitance parts are laminated on a single substrate in order to secure capacitance of the thin film silicon capacitor, performance thereof, such as current leakage and the like, may be easily deteriorated due to repetitive heat treatment of electrodes and dielectric layers constituting the capacitance parts and an increase in surface roughness.

### RELATED ART DOCUMENT

(Patent Document 1) Korean Patent Laid-Open Publication No. 2008-0010125

### SUMMARY OF THE INVENTION

An aspect of the present invention provides a capacitor having increased capacitance while significantly reducing an increase in the thickness thereof, and a method of manufacturing the same.

An aspect of the present invention also provides a capacitor capable of solving problems such as current leakage and the like due to repetitive heat treatments and an increase in surface roughness, and a method of manufacturing the same.

According to an aspect of the present invention, there is provided a capacitor, including: a substrate part including a first substrate having a groove portion and a second substrate positioned above the first substrate and having a protrusion portion; a first capacitance part formed on one surface of the first substrate and having a shape corresponding to that of the groove portion; and a second capacitance part formed on one surface of the second substrate and having a shape corresponding to that of the protrusion portion.

The capacitor may further include a protective layer formed between the first capacitance part and the second capacitance part.

The groove portion may include a plurality of grooves.

The protrusion portion may include a plurality of protrusions.

The first capacitance part may include a first lower electrode, a first dielectric layer, and a first upper electrode.

The second capacitance part may include a second lower electrode, a second dielectric layer, and a second upper electrode.

The protrusion portion may be positioned inside the groove portion.

The first and second upper and lower electrodes may include at least one metal selected from the group consisting of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

The first and second dielectric layers may include at least one of lead zirconate titanate class materials (PZT, PLZT, PNZT), barium titanate (BTO), barium strontium titanate (BST), strontium titanium oxide (STO), lead titanate (PTO), antimony tin oxide (ATO), titanium dioxide (TiO₂), and tantalum oxide (Ta₂O₅), aluminum oxide (Al₂O₂), niobium oxide (Nb₂O₅), silicon nitride (Si₃N₄), and silicon dioxide (SiO₂).

The capacitor may further include: lower electrode pads connected to the first lower electrode and the second lower electrode, respectively; and upper electrode pads connected to the first upper electrode and the second upper electrode, respectively.

The capacitor may further include: first upper and lower electrode pads connected to the first lower electrode and the second upper electrode, respectively; and second upper and lower electrode pads connected to the first upper electrode and the second lower electrode, respectively.

According to another aspect of the present invention, there is provided a method of manufacturing a capacitor, the method including: preparing a first structure body including a first capacitance part, a first protective layer, and first electrode pads, formed on a first substrate having a groove portion; preparing a second structure body including a second capacitance part, a second protective layer, and second electrode pads, formed on a second substrate having a protrusion portion; and bonding the second structure body to an upper surface of the first structure body while the groove portion of the first substrate and the protrusion portion of the second substrate are disposed in positions corresponding to each other.

The preparing of the first structure body may include: preparing the first substrate having the groove portion; forming the first capacitance part on one surface of the first substrate, the first capacitance part having a shape corresponding to that of the groove portion; forming the first protective layer on an upper surface of the first capacitance part; and forming the first electrode pads on one surface of the first substrate.

The preparing of the second structure body may include: preparing the second substrate having the protrusion portion; forming the second capacitance part on one surface of the second substrate, the second capacitance part having a shape corresponding to that of the protrusion portion; forming the second protective layer on an upper surface of the second capacitance part; and forming the second electrode pads in depressed regions of the second substrate.

The forming of the first capacitance part may include: forming a first lower electrode on one surface of the first substrate; forming a first dielectric layer on an upper surface of the first lower electrode; and forming a first upper electrode on an upper surface of the first dielectric layer. The forming of the first electrode pads may include: forming a first lower electrode pad connected to the first lower electrode; and forming a first upper electrode pad connected to the first upper electrode.

The forming of the second capacitance part may include: forming a second lower electrode on one surface of the second substrate; forming a second dielectric layer on an upper surface of the second lower electrode; and forming a second upper electrode on an upper surface of the second dielectric layer. The forming of the second electrode pads includes: forming a second lower electrode pad connected to the second lower electrode; and forming a second upper electrode pad connected to the second upper electrode.

The bonding of the second structure body to the upper surface of the first structure body may include: bonding the first upper electrode pad and the second upper electrode pad to each other; and bonding the first lower electrode pad and the second lower electrode pad to each other.

The bonding of the second structure body to the upper surface of the first structure body may include: bonding the first upper electrode pad and the second lower electrode pad to each other; and bonding the first lower electrode pad and the second upper electrode pad to each other.

The method may further include grinding the second electrode pads formed in the depressed regions.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a capacitor according to an embodiment of the present invention;

FIGS. 2A and 2B are exploded views of the capacitor according to the embodiment of the present invention;

FIGS. 3A to 3F are views showing a method of manufacturing a first structure body according to another embodiment of the present invention;

FIGS. 4A to 4F are views showing a method of manufacturing a second structure body according to another embodiment of the present invention;

FIGS. 5A and 5B are views showing a method of manufacturing a capacitor according to another embodiment of the present invention; and

FIGS. 6A to 6C are views showing capacitors according to embodiments of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

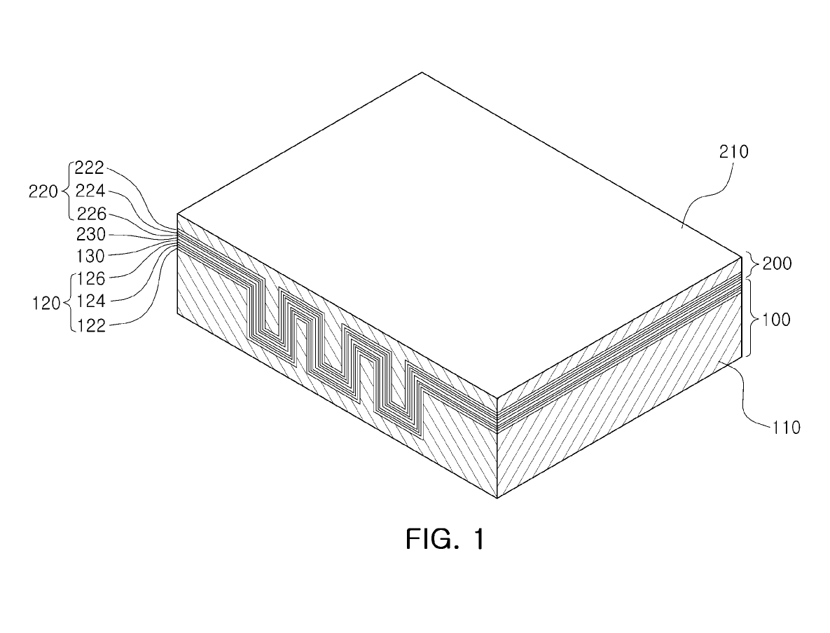

FIG. 1 is a perspective view of a capacitor according to an embodiment of the present invention.

Referring to FIG. 1, a capacitor according to the present embodiment of the invention may include a first structure body 100 and a second structure body 200.

The capacitor may be formed by bonding one surface of the first structure body 100 to one surface of the second structure body 200.

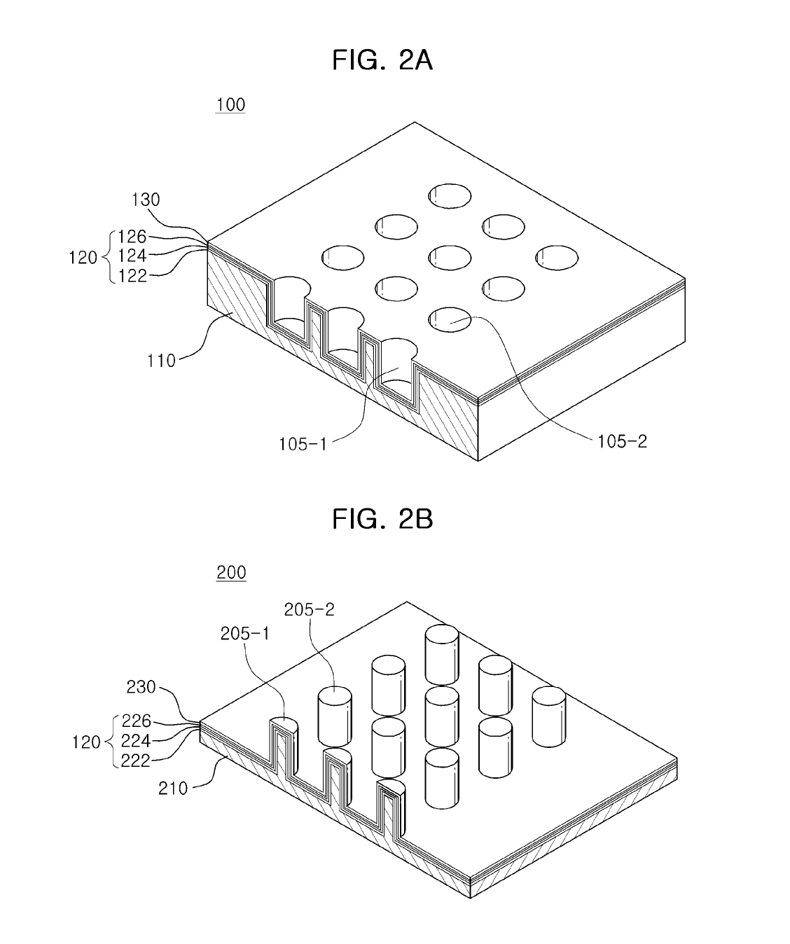

FIGS. 2A and 2B are exploded views of the capacitor according to the embodiment of the present invention. FIG. 2A shows the first structure body 100 according to the embodiment of the present invention. FIG. 2B shows the second structure body 200 according to the embodiment of the present invention.

Referring to FIG. 2A, the first structure body 100 may include a first substrate 110, a first capacitance part 120, and a first protective layer 130.

The first substrate 110 may be a silicon or polymer complex-based substrate on which an insulating layer is formed. For example, the polymer complex-based substrate may be formed of polyimide or epoxy that is often used for a printed circuit board.

A groove portion 105 may be formed in the first substrate 110. The groove portion 105 may include a plurality of grooves 105-1 and 105-2.

The grooves 105-1 and 105-2 may be formed to have various shapes. For example, the shape of the groove may be cylindrical, conical, prismatic, pyramidal, or the like.

The first capacitance part 120 may generate capacitance. The first capacitance part 120 may include a first lower electrode 122, a first dielectric layer 124, and a first upper electrode 126.

The first lower electrode 122 may be formed on one surface of the first substrate 110. The first dielectric layer 124 may be formed on one surface of the first lower electrode 122. The first upper electrode 126 may be formed on one surface of the first dielectric layer 124.

The first lower electrode 122 and the first upper electrode 126 may be formed of at least one metal selected from the group consisting of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

The first dielectric layer 124 may include at least one of lead zirconate titanate class materials (PZT, PLZT, PNZT, or the like), barium titanate (BTO), barium strontium titanate (BST), strontium titanium oxide (STO), lead titanate (PTO), antimony tin oxide (ATO), titanium dioxide (TiO₂), and tantalum oxide (Ta₂O₅), aluminum oxide (Al₂O₃), niobium oxide (Nb₂O₅), silicon nitride (Si₃N₄), and silicon dioxide (SiO₂).

The first dielectric layer 124 may be formed by physical vapor deposition (PVD) such as sputtering process, or the like, chemical vapor deposition (CVD), atomic layer deposition (ALD), a chemical solution deposition (CSD) using sol-gel, or the like.

The first protective layer 130 may be formed on one surface of the capacitance part 120. The first protective layer 130 may be an inorganic protective layer of SiNₓ, SiOₓ, TiOₓ, SiON, AlOₓ, or the like, or an organic protective layer of polyimide resin, epoxy resin, or the like.

As shown in FIG. 2A, the first capacitance part 120 may be formed to have a shape corresponding to one surface of the first substrate 110 having the plurality of grooves 105-1 and 105-2. Also, the first protective layer 130 may be formed to have a shape corresponding to one surface of the first substrate 110 having the plurality of grooves 105-1 and 105-2.

Referring to FIG. 2B, the second structure body 200 may include a second substrate 210, a second capacitance part 220, and a second protective layer 230.

The second substrate 210 may be a silicon or polymer complex-based substrate on which an insulating layer is formed. For example, the polymer complex-based substrate may be formed of polyimide or epoxy that is often used for a printed circuit board.

A protrusion portion 205 may be formed on the second substrate 210. The protrusion portion 205 may include a plurality of protrusions 205-1 and 205-2.

The protrusion portion 205 may be formed to have a shape corresponding to the groove portion 105. For example, the shapes of the protrusions 205-1 and 205-2 may be cylindrical, conical, prismatic, pyramidal, or the like.

The second capacitance part 220 may generate a capacitance. The second capacitance part 220 may include a second lower electrode 222, a second dielectric layer 224, and a second upper electrode 226.

The second lower electrode 222 may be formed on one surface of the second substrate 210. The second dielectric layer 224 may be formed on one surface of the second lower electrode 222. The second upper electrode 226 may be formed on one surface of the second dielectric layer 224.

The second lower electrode 222 and the second upper electrode 226 may be formed of at least one metal selected from the group consisting of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

The second dielectric layer 224 may include at least one of lead zirconate titanate class materials (PZT, PLZT, PNZT, or the like), barium titanate (BTO), barium strontium titanate (BST), strontium titanium oxide (STO), lead titanate (PTO), antimony tin oxide (ATO), titanium dioxide (TiO₂), and tantalum oxide (Ta₂O₅), aluminum oxide (Al₂O₂), niobium oxide (Nb₂O₅), silicon nitride (Si₃N₄), and silicon dioxide (SiO₂).

The second dielectric layer 224 may be formed by physical vapor deposition (PVD) such as sputtering or the like, chemical vapor deposition (CVD), atomic layer deposition (ALD), a chemical solution deposition (CSD) using sol-gel, or the like.

The second protective layer 230 may be formed on one surface of the second capacitance part 220. The second protective layer 230 may be an inorganic protective layer of SiNₓ, SiOₓ, TiOₓ, SiON, AlOₓ, or the like, or an organic protective layer of polyimide resin, epoxy resin, or the like.

As shown in FIG. 2B, the second capacitance part 220 may be formed to have a shape corresponding to one surface of the second substrate 210 having the plurality of protrusions 205-1 and 205-2. Also, the second protective layer 230 may be formed to have a shape corresponding to one surface of the second substrate 210 having the plurality of protrusions 205-1 and 205-2.

Referring to FIG. 1 to FIG. 2B, the capacitor according to the present embodiment of the invention may be formed by bonding the second structure body 200 to one surface of the first structure body 100. Here, when bonded, the groove portion 105 of the first structure body 100 may correspond to the protrusion portion 205 of the second structure body 200. For example, the first structure body 100 and the second structure body 200 may be bonded to each other such that the protrusions 205-1 and 205-2 are positioned inside the grooves 105-1 and 105-2, respectively.

Meanwhile, the first protective layer 130 of the first structure body 100 and the second protective layer 230 of the second structure body 200 may be bonded to each other, and thus integrated with each other. Meanwhile, the first structure body 100 may include the first protective layer 130, but the second structure body 200 may not include the second protective layer 230. Alternately, the second structure body 200 may include the second protective layer 130, but the first structure body 100 may not include the first protective layer 130.

As described above, the first capacitance part 120 is formed inside the groove portion 105 of the first substrate 110 and the second capacitance part 220 formed in the protrusion portion 205 of the second substrate 210 is disposed inside the groove portion 105, so that capacitance of the capacitor can be increased while the thickness of the capacitor is significantly reduced.

According to the present embodiment of the invention, the first capacitance part 120 and the second capacitance part 220 are formed on separate substrates, respectively, and thus surface roughness is not significantly increased. In addition, since the first capacitance part 120 and the second capacitance part 220 are formed on separate substrates, respectively, the number of heat treatments applied to the respective capacitance parts 120 and 130 may be decreased.

Therefore, the capacitor according to the present embodiment of the invention can suppress current leakage or the like.

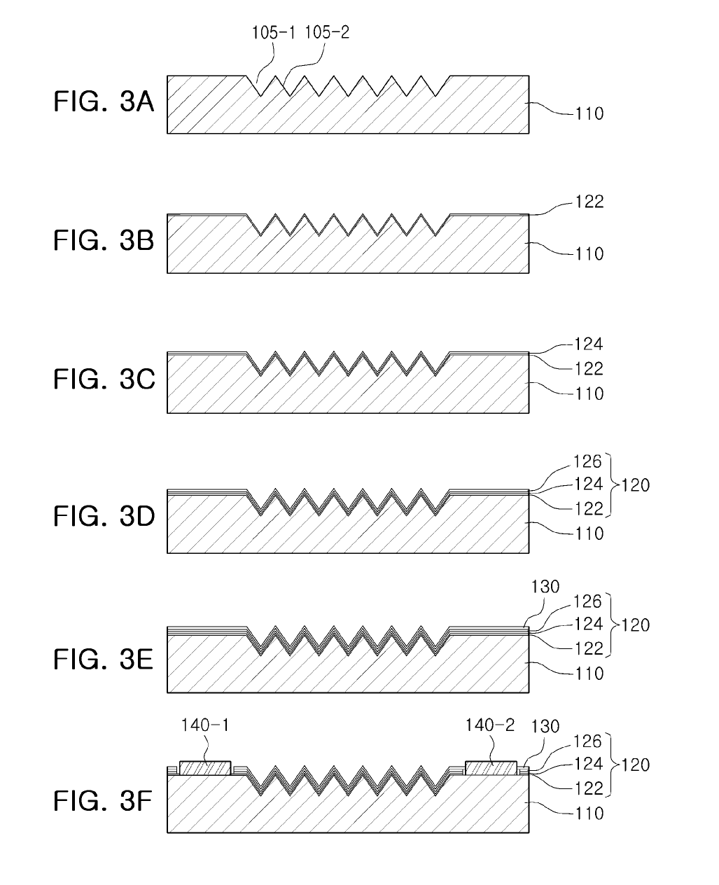

FIGS. 3A to 3F are views showing a method of manufacturing a first structure body according to another embodiment of the present invention.

According to the present embodiment of the invention, a first substrate 110 may be prepared (FIG. 3A). The first substrate 110 may include a plurality of grooves 105-1 and 105-2.

The shapes of the grooves 105-1 and 105-2 are not particularly limited. For example, the grooves 105-1 and 105-2 may be cylindrical, conical, prismatic, or pyramidal.

According to the present embodiment, a first lower electrode 122 may be formed on one surface of the first substrate 110 (FIG. 3B).

In addition, a first dielectric layer 124 may be formed on one surface of the first lower electrode 122 (FIG. 3C).

Here, the first dielectric layer 124 may be formed by physical vapor deposition (PVD) such as sputtering or the like, chemical vapor deposition (CVD), atomic layer deposition (ALD), a chemical solution deposition (CSD) using sol-gel, or the like.

In addition, a first upper electrode 126 may be formed on one surface of the first dielectric layer 124 (FIG. 3D).

In addition, a first protective layer 130 may be formed on one surface of the first upper electrode 126 (FIG. 3E).

According to the present embodiment of the invention, first electrode pads 140 may be formed on one surface of the first substrate 110. The first electrode pads 140 may include a first lower electrode pad 140-1 and a first upper electrode pad 140-2.

The term “lower electrode pad” is defined as an electrode pad connected to the lower electrode. In addition, the term “upper electrode pad” is defined as an electrode pad connected to the upper electrode.

Therefore, the forming of the first electrode pads 140 may include forming the first lower electrode pad 140-1 connected to the first lower electrode 122 and forming the first upper electrode pad 140-2 connected to the first upper electrode 126 (FIG. 3F).

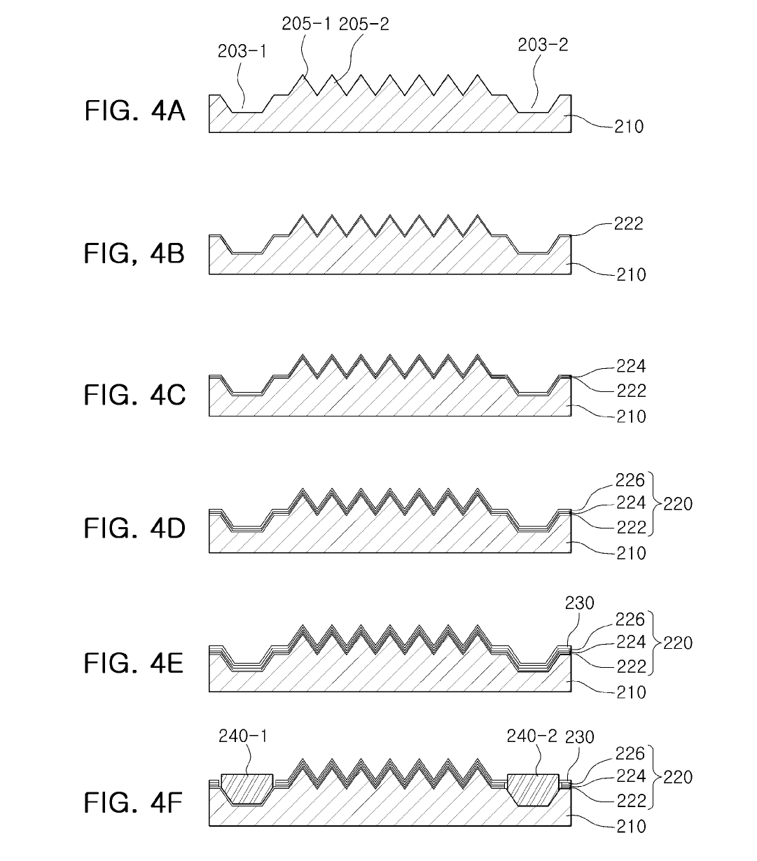

FIGS. 4A to 4F are views showing a method of manufacturing a second structure body according to another embodiment of the present invention.

According to the present embodiment of the invention, a second substrate 210 may be prepared (FIG. 4A). The second substrate 210 may include a plurality of protrusions 205-1 and 205-2.

The plurality of protrusions 205-1 and 205-2 may be formed in positions corresponding to the plurality of grooves 105-1 and 105-2.

The shapes of the protrusions are not particularly limited. For example, the protrusions 205-1 and 205-2 may be cylindrical, conical, prismatic, or pyramidal. The protrusions 205-1 and 205-2 may be formed to have a shape corresponding to the grooves 105-1 and 105-2.

In addition, the second substrate 210 may include a plurality of second electrode pad forming portions 203-1 and 203-2. For example, the second electrode pad forming portions 203-1 and 203-2 may be depressed regions where second electrode pads are to be formed. The depressed regions 203-1 and 203-2 may be formed in positions corresponding to the first upper and lower electrode pads 140-1 and 140-2 of the first substrate 110.

According to the present embodiment, a second lower electrode 222 may be formed on one surface of the second substrate 210 (FIG. 4B).

In addition, a second dielectric layer 224 may be formed on one surface of the second lower electrode 222 (FIG. 4C).

The second dielectric layer 224 may be formed by physical vapor deposition (PVD) such as sputtering or the like, chemical vapor deposition (CVD), atomic layer deposition (ALD), a chemical solution deposition (CSD) using sol-gel, or the like.

Then, a second upper electrode 226 may be formed on one surface of the second dielectric layer 224 (FIG. 4D).

Then, a second protective layer 230 may be formed on one surface of the second upper electrode 226 (FIG. 4E).

According to the present embodiment, second electrode pads 240 may be formed on one surface of the second substrate 210.

For example, the second electrode pads 240 may be formed in the depressed regions 203-1 and 203-2 formed in the second substrate.

The second electrode pads 240 may include a second lower electrode pad 240-1 and a second upper electrode pad 240-2.

Therefore, the forming of the second electrode pads 240 may include: forming the second lower electrode pad 240-1 connected to the second lower electrode 222 and forming the second upper electrode pad 240-2 connected to the second upper electrode 226 (FIG. 4F).

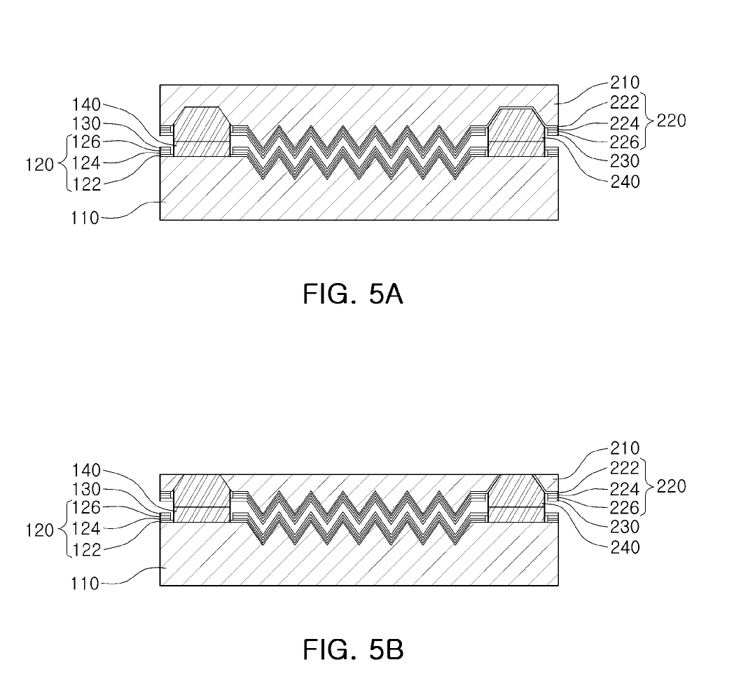

FIGS. 5A and 5B are views showing a method of manufacturing a capacitor according to another embodiment of the present invention.

According to the present embodiment of the invention, the second structure body 200 may be bonded to an upper surface of the first structure body 100 (FIG. 5A).

Here, the protrusion portion 205 of the second structure body 200 may be disposed in a position corresponding to the groove portion 105 of the first structure body 100. In addition, the second electrode pad 240 of the second structure body 200 may be disposed in a position corresponding to the first electrode pad 140 of the first structure body 100. Therefore, the second electrode pad 240 may be bonded to one surface of the first electrode pad 140.

For example, the bonding of the second electrode pad to one surface of the first electrode pad may include: bonding the first upper electrode pad and the second upper electrode pad to each other; and bonding the first lower electrode pad and the second lower electrode pad to each other.

Alternatively, the bonding of the second electrode pad to one surface of the first electrode pad may include: bonding the first upper electrode pad and the second lower electrode pad to each other; and bonding the first lower electrode pad and the second upper electrode pad to each other.

Meanwhile, a bonded body of the first upper electrode pad and the second lower electrode pad may be connected to the first upper electrode and the second lower electrode. In addition, a bonded body of the first lower electrode pad and the second upper electrode pad may be connected to the first lower electrode and the second upper electrode. As such, electrode pads that are connected to the upper and lower electrodes are defined as upper and lower electrode pads, respectively.

Here, an empty space may be present between the first protective layer 130 and the second protective layer 230.

Alternatively, the first protective layer 130 of the first structure body 100 and the second protective layer 230 of the second structure body 200 may be bonded to each other, and thus integrated with each other.

The first protective layer 130 and the second protective layer 230 may have the empty space therebetween, or the first protective layer 130 and the second protective layer 230 may be bonded to and integrated with each other, depending on the heights of the first electrode pad 140 and the second electrode pad 240.

According to the present embodiment of the invention, one surface of the second structure body 200 may be ground (FIG. 5B). For example, one surface of the second structure body 200 may be subjected to grinding. The grinding process may reduce the thickness of the capacitor.

In the case in which one surface of the second structure body 200 is ground, the second electrode pad 240 may be exposed. The exposed electrode pad may be connected to an external circuit.

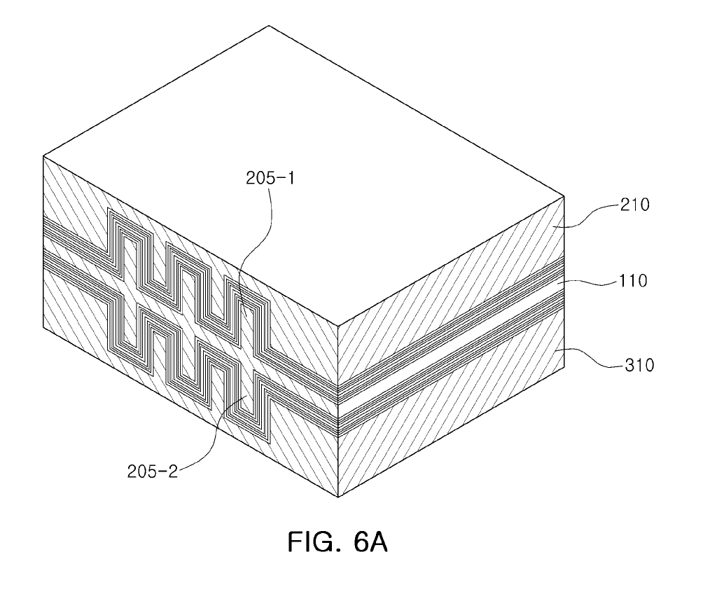

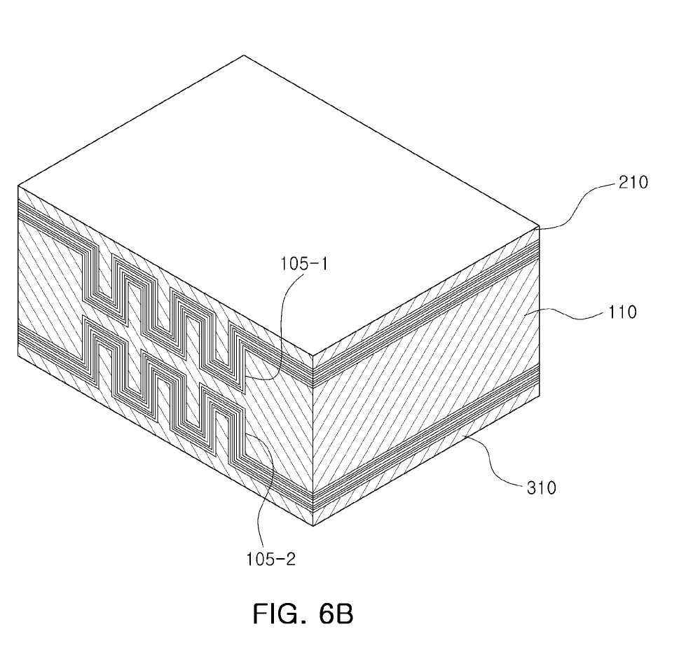

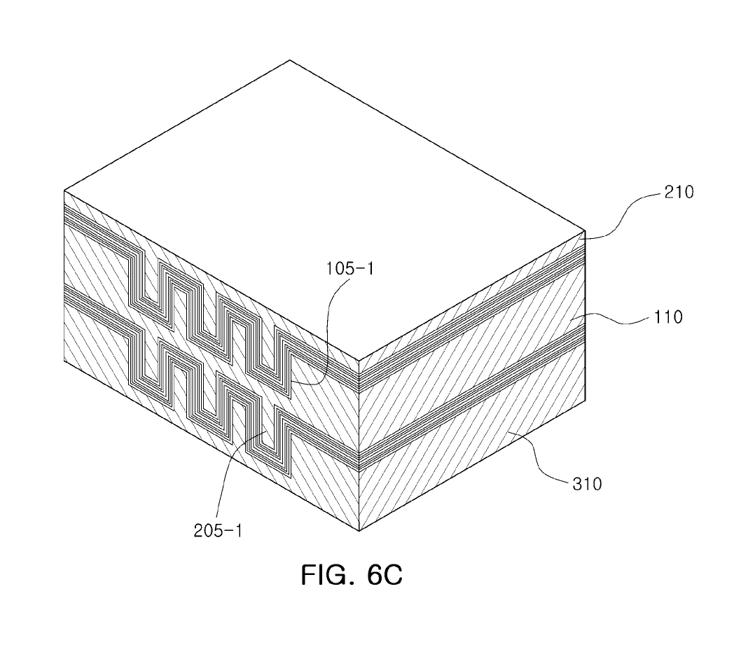

FIGS. 6A to 6C are views showing capacitors according to embodiments of the present invention.

Referring to FIG. 6A to 6C, a capacitor including a plurality of dielectric layers may be manufactured using a plurality of substrates 110, 210, and 310.

Referring to FIG. 6A, a capacitor including a plurality of dielectric layers may be formed, based on the capacitor shown in FIG. 1.

Here, protrusions 205-1 and 205-2 may be formed on both surfaces of the first substrate 110.

FIG. 6B shows a capacitor in which grooves 105-1 and 105-2 are formed in both surfaces of the first substrate.

FIG. 6C shows a capacitor in which a shape of a cross section of the capacitor shown in FIG. 1 is periodically repeated.

Here, protrusions 205-1 may be formed on one surface of the first substrate 110 and grooves 105-1 may be formed in the other surface of the first substrate 110. That is, the protrusions 205-1 may be provided on a lower surface of the first substrate 110 and the grooves 105 may be provided in an upper surface of the first substrate 110.

In addition, protrusions may be formed on a lower surface of the second substrate 210, so that the protrusions correspond to the grooves formed in the upper surface of the first substrate. In addition, grooves may be formed in an upper surface of the second substrate 210. That is, the protrusions may be formed on the lower surface of the second substrate 210 and the grooves may be formed in the upper surface of the second substrate 210.

As such, the capacitor including the plurality of dielectric layers may be formed by repeatedly stacking the substrates having both the grooves and the protrusions.

As set forth above, in a capacitor and a method of manufacturing the same according to embodiments of the present invention, capacitance of the capacitor can be increased while a thickness thereof is significantly reduced.

Further, in a capacitor and a method of manufacturing the same according to embodiments of the present invention, current leakage due to an increase in surface roughness can be suppressed.

While the present invention has been shown and described in connection with the embodiments, it will be apparent to those skilled in the art that modifications and variations can be made without departing from the spirit and scope of the invention as defined by the appended claims.

What is claimed is:

1. A capacitor, comprising:
a substrate part including a first substrate having a groove portion and a second substrate positioned above the first substrate and having a protrusion portion;
a first capacitance part formed on one surface of the first substrate and having a shape corresponding to that of the groove portion; and
a second capacitance part formed on one surface of the second substrate and having a shape corresponding to that of the protrusion portion.

2. The capacitor of claim 1, further comprising a protective layer formed between the first capacitance part and the second capacitance part.

3. The capacitor of claim 1, wherein the groove portion includes a plurality of grooves.

4. The capacitor of claim 1, wherein the protrusion portion includes a plurality of protrusions.

5. The capacitor of claim 1, wherein the first capacitance part includes a first lower electrode, a first dielectric layer, and a first upper electrode.

6. The capacitor of claim 5, wherein the second capacitance part includes a second lower electrode, a second dielectric layer, and a second upper electrode.

7. The capacitor of claim 1, wherein the protrusion portion is positioned inside the groove portion.

8. The capacitor of claim 5, wherein the first and second upper and lower electrodes include at least one metal selected from the group consisting of copper (Cu), silver (Ag), gold (Au), aluminum (Al), tin (Sn), ruthenium (Ru), strontium (Sr), lanthanum (La), iridium (Ir), nickel (Ni), cobalt (Co), molybdenum (Mo), and tungsten (W).

9. The capacitor of claim 5, wherein the first and second dielectric layers include at least one of lead zirconate titanate class materials (PZT, PLZT, PNZT), barium titanate (BTO), barium strontium titanate (BST), strontium titanium oxide (STO), lead titanate (PTO), antimony tin oxide (ATO), titanium dioxide (TiO₂), and tantalum oxide (Ta₂O₅), aluminum oxide (Al₂O₃), niobium oxide (Nb₂O₅), silicon nitride (Si₃N₄), and silicon dioxide (SiO₂).

10. The capacitor of claim 6, further comprising:
lower electrode pads connected to the first lower electrode and the second lower electrode, respectively; and
upper electrode pads connected to the first upper electrode and the second upper electrode, respectively.

11. The capacitor of claim 6, further comprising:
first upper and lower electrode pads connected to the first lower electrode and the second upper electrode, respectively; and
second upper and lower electrode pads connected to the first upper electrode and the second lower electrode, respectively.

12. A method of manufacturing a capacitor, the method comprising:
preparing a first structure body including a first capacitance part, a first protective layer, and first electrode pads, formed on a first substrate having a groove portion;
preparing a second structure body including a second capacitance part, a second protective layer, and second electrode pads, formed on a second substrate having a protrusion portion; and
bonding the second structure body to an upper surface of the first structure body while the groove portion of the first substrate and the protrusion portion of the second substrate are disposed in positions corresponding to each other.

13. The method of claim 12, wherein the preparing of the first structure body includes:
preparing the first substrate having the groove portion;
forming the first capacitance part on one surface of the first substrate, the first capacitance part having a shape corresponding to that of the groove portion;
forming the first protective layer on an upper surface of the first capacitance part; and
forming the first electrode pads on one surface of the first substrate.

14. The method of claim 13, wherein the preparing of the second structure body includes:
preparing the second substrate having the protrusion portion;
forming the second capacitance part on one surface of the second substrate, the second capacitance part having a shape corresponding to that of the protrusion portion;
forming the second protective layer on an upper surface of the second capacitance part; and
forming the second electrode pads in depressed regions of the second substrate.

15. The method of claim 14, wherein the forming of the first capacitance part includes:
forming a first lower electrode on one surface of the first substrate;
forming a first dielectric layer on an upper surface of the first lower electrode; and
forming a first upper electrode on an upper surface of the first dielectric layer, and
the forming of the first electrode pads includes:
forming a first lower electrode pad connected to the first lower electrode; and
forming a first upper electrode pad connected to the first upper electrode.

16. The method of claim 15, wherein the forming of the second capacitance part includes:
forming a second lower electrode on one surface of the second substrate;
forming a second dielectric layer on an upper surface of the second lower electrode; and
forming a second upper electrode on an upper surface of the second dielectric layer, and
the forming of the second electrode pads includes:
forming a second lower electrode pad connected to the second lower electrode; and
forming a second upper electrode pad connected to the second upper electrode.

17. The method of claim 16, wherein the bonding of the second structure body to the upper surface of the first structure body includes:
bonding the first upper electrode pad and the second upper electrode pad to each other; and
bonding the first lower electrode pad and the second lower electrode pad to each other.

18. The method of claim 16, wherein the bonding of the second structure body to the upper surface of the first structure body includes:
bonding the first upper electrode pad and the second lower electrode pad to each other; and
bonding the first lower electrode pad and the second upper electrode pad to each other.

19. The method of claim 17, further comprising grinding the second electrode pads formed in the depressed regions.
